(19) United States
(12) Patent Application Publication
(10) Pub. No.: US 2019/0093551 A1
(43) Pub. Date: Mar. 28, 2019

(54) Energy Burst Engine

(71) Applicant: Olin Dannel Roberts, Jefferson City, MO (US)

(72) Inventor: Olin Dannel Roberts, Jefferson City, MO (US)

(21) Appl. No.: 16/168,643

(22) Filed: Oct. 23, 2018

Related U.S. Application Data
(63) Continuation-in-part of application No. 15/700,081, filed on Sep. 9, 2017.
Application No. 15/700,081 is a continuation-in-part of application No. 14/542,212, filed on Nov. 14, 2014, now abandoned.
Application No. 14/542,212 is a continuation-in-part of application No. 13/949,487, filed on Jul. 24, 2013, now abandoned.
(60) Provisional application No. 61/675,568, filed on Jul. 25, 2012.

(51) Int. Cl. F02B 53/12; F02B 43/12

(52) U.S. Cl. CPC F02B 53/12; F01C 1/22; F02B 43/12

(57) ABSTRACT

An engine comprises a rotor disposed within a housing having a side wall, a top portion, and a bottom portion. The housing includes at least one energy burst ignition chamber and electrical device that introduces an electric charge into at least one energy burst ignition chamber. The rotor is constructed and arranged to spin within the housing by action of a force. At least one energy burst ignition chamber is constructed and arranged to electrically react with the gas disposed in at least one chamber such that the gas expands and drives the rotor. A control system is used for introducing electric charges into at least one energy burst ignition chamber at a controlled time interval.

### CROSS-REFERENCE TO RELATED APPLICATIONS

This application is a continuation in part of U.S. Non-provisional application Ser. No. 15/700,081 filed Sep. 9, 2017 which is a Continuation in part of U.S. Non-provisional application Ser. No. 14/542,212 filed Nov. 14, 2014 which is a continuation in part of U.S. Non-provisional application Ser. No. 13/949,487 filed Jul. 24, 2013 which claims the benefit of U.S. Provisional Application No. 61/675,568, filed Jul. 25, 2012.

### STATEMENT REGARDING FEDERALLY SPONSORED RESEARCH

Not Applicable

### FIELD OF THE INVENTION

This invention relates to an engine powered by a burst of energy initiated by passing an electrical charge through a gas.

### BACKGROUND OF THE INVENTION

The combustion engine has utilized volatile fluids in order to create explosions to create mechanical power. The combustion engine loses efficiency by creating heat and other energy drains; the heat can also result in material fatigue and requires lubrication in order to perform acceptably. Additionally, the combustion engine requires fuel that is often imported from other countries. There exists a need for an engine that delivers power and efficiency that is powered from sources fully available domestically.

The instant invention as disclosed within this application, provides an engine that fills this need. The art referred to and/or described within this application is not intended to constitute an admission that any patent, publication or other information referred to herein is “prior art” with respect to this invention. In addition, this section should not be construed to mean that a thorough search has been made or that no other pertinent information as defined in 37 C.F.R. § 1.56(a) exists.

All US patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

### BRIEF SUMMARY OF THE INVENTION

In at least one embodiment of the invention, a rotor is disposed within a housing having side wall(s), a top portion, and a bottom portion. The housing includes an energy burst ignition chamber which contains a gas mixture. As used herein the gas mixture can include one or more elements and can also be introduced into the ignition chamber in liquid form. Some mixtures include noble gases. Some mixtures of gases are entirely noble gases. Some mixtures include mostly nitrogen, and some, entirely nitrogen. Some mixtures are entirely air without a hydrocarbon component. The gas mixture included within the engine can be selected from the group including one or more noble gases, one or more homonuclear diatomic molecules, and any combination thereof. The term “gas mixture” applies to the mixture of gas at the time of ignition. After ignition, the gas mixture may change its state/phase such that there is a plasma phase.

An electrical device that introduces an electric charge into the energy burst ignition chamber can form an energy burst. The rotor is designed to spin when hit by the energy burst. The spinning of the rotor can perform useful work.

In at least one embodiment the invention can include at least one nozzle with one end passing into the interior of the housing. The nozzle can be used to create a vacuum within the energy burst ignition chamber and/or to introduce a mixture of gas into the energy burst ignition chamber.

In at least one embodiment the rotor has a notch, notched portion, or groove such that the energy burst can strike the surface of the notch or groove in order to direct the energy of the burst in a way that creates greater rotation about the shaft. Notch, notched portion, or groove: all generally describe the area on the rotor that is designed to receive the energy burst. In a circular or oval rotor this can appear to be a notched out area. The term “circular”, “elliptical”, or “oval” here can refer to the general shape of the rotor if it had no notches or grooves. So while a rotor with many notches as seen in FIG. 6 might not first appear to be circular or oval, the terms can apply because if the notches were not there, it could have a circular or oval shape. In some embodiments of FIG. 6, the outermost portions of the rotor are constructed such that the outermost portions of the rotor would resemble the shape of an oval, ellipse, and/or circle if the notches or grooves were not present. In some specific instances the area might be an actual groove that is rounded or cupped.

In at least one embodiment the rotor has multiple notches/grooves.

In at least one embodiment the invention includes a timing mechanism such that the energy burst is timed to strike the surface of the notch(es) or groove(s) as the rotor spins about the shaft.

In at least one embodiment the invention includes multiple ignition chambers. In some embodiments the multiple ignition chambers work to rotate the rotor in the same direction. In some embodiments one or more ignition chambers are designed to create an energy burst that turns the rotor in the opposite direction that another ignition chamber turns the rotor. This can be used as a brake and/or as a reverse.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A description of the invention is hereafter described with specific reference being made to the drawing.

FIG. 1 is a perspective view of an energy burst engine rotor with a single groove or notch.

FIG. 2 is a cross-sectional top view of a housing.

FIG. 3 is a schematic exploded perspective view of the bottom plate, housing, rotor, and top plate.

FIG. 4a is a cross-sectional top view of a housing with a grooved rotor illustrating the energy burst ignition chamber and the energy burst expansion chamber.

FIG. 4b is a cross-sectional top view of a housing with a grooved rotor illustrating multiple energy burst ignition chambers and energy burst expansion chambers.

FIG. 5 is a cross-sectional top view of a housing having multiple energy burst ignition chambers and a rotor having multiple grooves.

FIG. 6 is a cross-sectional top view of a housing having multiple energy burst ignition chambers and a pressure valve and line.

FIGS. 7a-e are cross-sectional top views of a housing with a rotor and valve illustrating the position of the rotor and valve before, during, and after ignition within an energy burst ignition chamber and energy burst expansion chamber.

FIG. 8 is a cross-sectional top view of a housing with multiple rotors and a valve.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. The term groove or notch refers to any design of the rotor that creates a leading edge for the energy burst wave to strike.

Either that burst of energy or one similar can be created with an electrical charge inside of a sealed cylinder (or housing) containing a single or a combination of gases. To make the engine run, an electrical charge can be introduced into the gases and can produce a discharge that is similar to lightning. That discharge causes an increase in pressure, which can cause the engine to spin. The discharge could be a plasma burst, a small fission release in the gases, a small fusion release in the gases or a small release of atomic energy from the gases or could be any combination of these.

That chamber will be called the Energy Burst Ignition Chamber in this invention. This burst of energy produces a large wave of pressure which then quickly collapses and returns to the starting pressure of the gas and produces little to no heat or exhaust gases. This invention can take advantage of the pressure wave and the immediate collapse that follows.

The energy burst is designed to happen in the Energy Burst Ignition Chamber which can then drive or push against one or more of the leading edges in the Energy Burst Expansion Chamber, thus causing the rotor to turn. The turning motion from the rotor can be used for work.

The gases that can be used within the energy burst ignition chamber can be regular air. Higher levels of nitrogen in the gas can be used. In some embodiments, only nitrogen is present in the ignition chamber. In other embodiments, air-free and/or oxygen-free environments are desired. A noble gas mixture and/or a halogen can also be used. A high content of chlorine gas has been seen to be effective. Uranium and/or plutonium gases can also be used. In some embodiments, a noble gas mixture and/or a halogen can be used while being air-free and/or oxygen-free. Uranium and/or plutonium gases can also be used while being air-free and/or oxygen-free.

The housing can be made of any material durable enough to run the engine. Plastics, polymers, ceramics, metals and all alloys of these can be used separately or in combination. Stainless steel can be used to good effect. Non-aluminum metals or alloys have also been used to good effect for the housing.

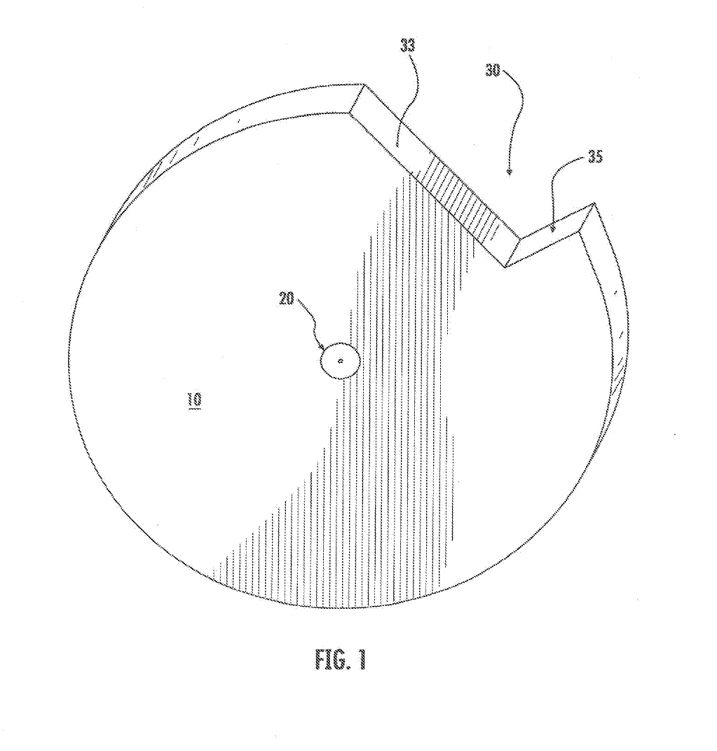

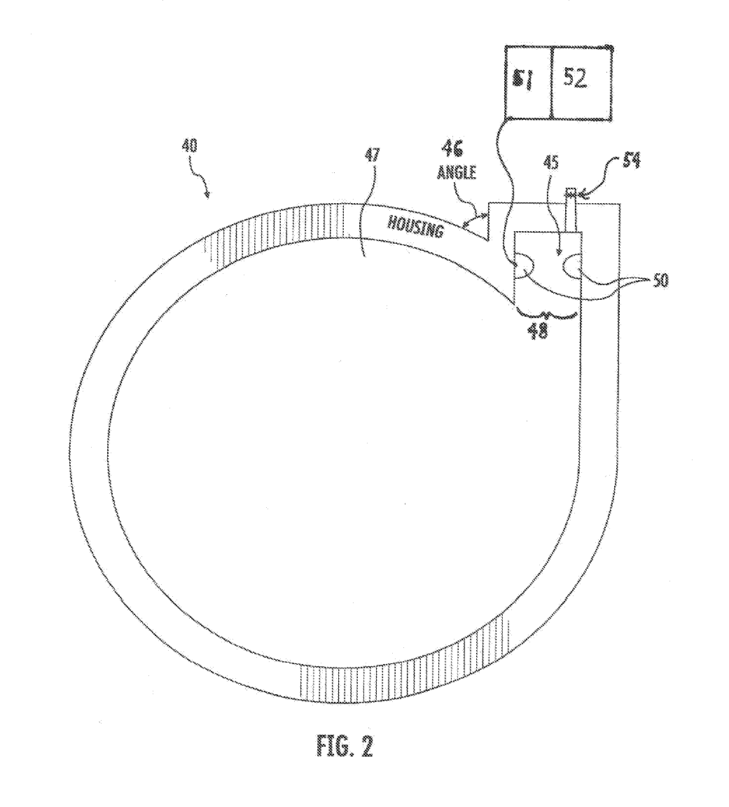

In FIG. 1 a circular or elliptical rotor 10 with a shaft 20 there through is shown. Also shown is a cut-out section 30 that can be a portion of an energy burst expansion chamber 45 (see FIG. 2). Shown here, the cut out section 30 includes a trailing edge 33 and a leading edge 35. As designed the leading edge 35 provides a surface or shape that can be modified to capture a maximum amount of energy from the movement of the pressure wave coming out of the energy burst ignition chamber 45. The trailing edge 33 here is designed to capture as little of the energy coming out of the energy burst ignition chamber as possible. Though in some embodiments, it may be desirable for the trailing edge to capture more energy. Note, the “cut out section” is not meant to imply or teach a method on forming the cut out section. It is only describing the appearance of the finished product.

Either of the two edges may be flat, straight, curved, or grooved. It is up to the user or builder as to the shapes of the edges that can be used to achieve the desired effects. Multiple cut-out sections 30 facilitating multiple energy burst expansion chambers can be added as well. FIG. 5 illustrates this multiplicity of sections. In some embodiments the rotor is not circular and is star shaped. In some embodiments the rotor 10 is bar or blade shaped; the rotor is not oval but rather is straight and elongated, akin to a blade within a mower housing. A burst would strike the blade or bar such that it rotates. The control system 52 (FIG. 2) would then communicate with the electrical device 51 to deliver another electrical spark, charge, or impulse that delivers a burst directed to the outer end of the bar or blade (or some other location of the bar or blade) as it is spinning; the location can be adjusted by adjusting the angle 46 of the housing about the expansion chamber 45.

FIG. 2 illustrates an energy burst engine block 40 with a single energy burst ignition chamber 45. The rotor 10 of FIG. 1 is designed to fit into the hole 47 of the engine block 40. The nobs 50 are shown here disposed within the energy burst ignition chamber 45. These knobs 50 can carry an electric spark or charge into the ignition chamber. These knobs can include radio frequency transmitters, electrodes, and spark plugs. The charge is sent by an activation device 51 (e.g. an electrical device) capable of sending a large number of charges in a short period of time and capable of being acted on and adjusted by a programmable control device 52 that can deliver control to the activation device 51 in a preferred manner. Electrical devices and controllers capable of this are known in the art. The charge or spark can cause the energy burst and expansion. In some embodiments, the charge is highly intermittent and the capability of providing multiple charges per second is not necessary. In some embodiments the charge is only given once. In other embodiments only several to a dozen times a minute. There is a nozzle 54 that can be used to vacuum out the entire engine and to charge or fill it with the gases. The nozzle can be placed anywhere, as the builder would desire. The angle 46 and/or shape of the energy burst ignition chamber 45 can be changed or configured so that it can direct the energy burst to interact with the rotor to achieve a desired effect.

It should be noted that there are other ways than electrical means in which to activate the gas expansion within an energy burst ignition chamber 45. In some embodiments the activation device 51 initiating the gas expansion can be created using an activation device 51 that creates an initiator that can be an electric charge, an electric impulse, an electromagnetic frequency, heat, a spark, a flame, a magnetic impulse, high pressure, or any combination that is delivered to the knobs 50.

The energy burst chamber 45 can have a narrower opening 48 than that shown in FIG. 2 such that the force of the burst is more localized to a specific location on the rotor 10. The chamber 45 can be designed such that the force of the burst strikes the rotor 10 just inside the radial edge in order increase the work that is done. The more the energy burst pushes against the leading edge, the more power that can be produced. Multiple Energy Burst Ignition Chambers can be configured as shown in FIG. 5. It can also have a wider opening 48. A valve can also be used. In some embodiments the chamber 45 can have an adjustable opening 48 that can be used to adjust the force and direction of the burst.

The Energy Burst Ignition Chamber 45 could be bolted or added on to an opening in the housing rather than it being a part of the block as shown.

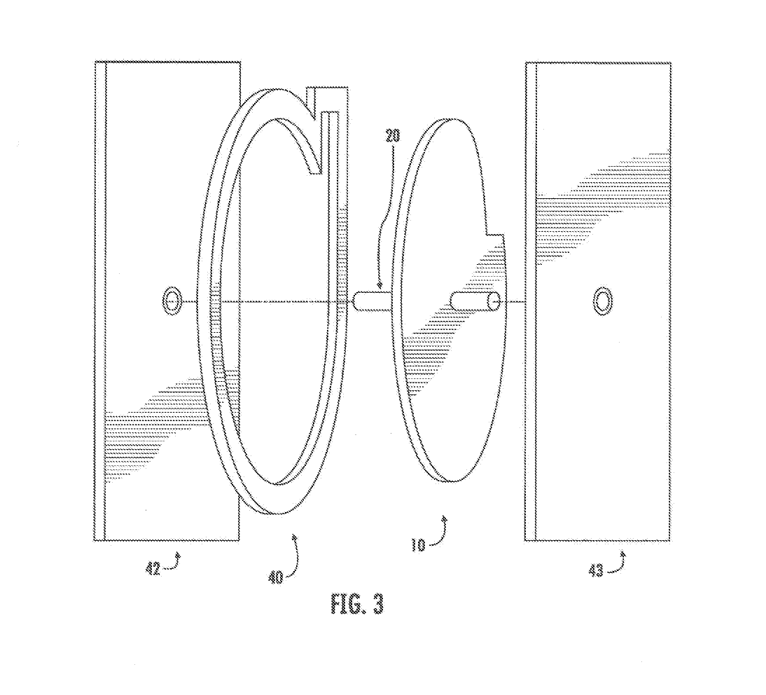

FIG. 3 shows a partially exploded illustration of an embodied engine 5: a bottom portion 42, a block or housing 40 forming the sidewall for the engine, a rotor 10 with a shaft 20, and a top portion 43. The top and bottom portions 43/42 can be constructed of a top plate and bottom plate. The shaft as shown passing through the rotor can connect the four components of FIG. 3. In some embodiments the shaft 20 does not pass all the way through. In some embodiments the shaft is only attached to a single portion/plate 42 or 43. It should be pointed out that the rotor 10 can also have an elliptical or oval shape. While FIG. 3 is a perspective view, figure can also be used to illustrate a rotor 10 that has this shape in a flat view. Thus, the rotor 10 would be oval and/or non-circularly elliptical but could be housed in a circular housing as in FIG. 2 or other shaped housing.

In many embodiments the engine housing is sealed airtight once it is put together. Sealing is well-known in the art. The bottom plate 42 can have a hole for one side of the shaft 20 which goes through the rotor 10. Bearings can be used as needed. The block 40 and rotor 10 can reside against the bottom plate 42. The top plate 43 can then be placed over the block 40 and rotor 10. The top plate 43 also can have a hole for the other side of the shaft 20 which goes through the rotor 10. The plates 42,43 and housing 40 then can be bolted or welded together or the like to hold them in place and to seal them. The rotor 10 can now spin between the plates and inside the housing. The bottom plate 42 and the housing 40 could be all one machined piece if desired. The top plate 43 and housing 40 could be as well. In some embodiments, being sealed airtight can mean that no air can enter the sealed housing. In some embodiments a very small amount of air may enter such that it has a minimal effect on the reaction.

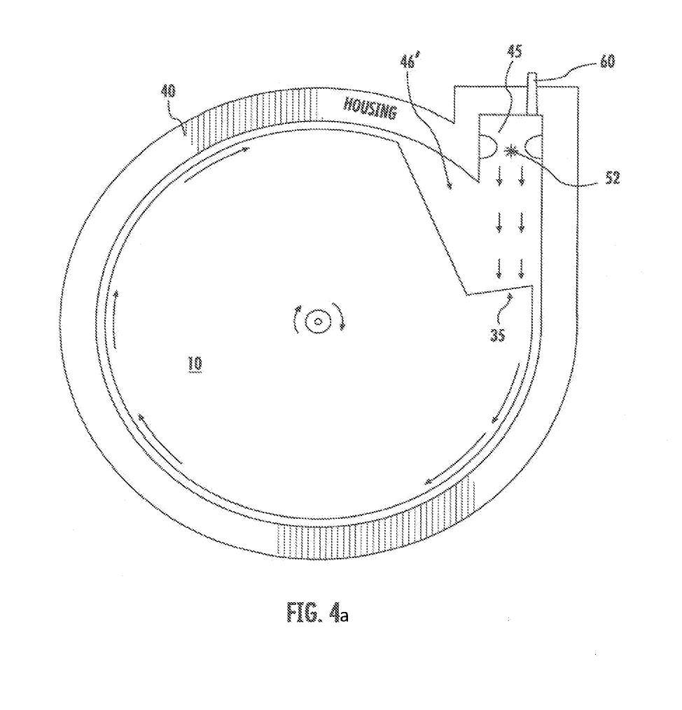

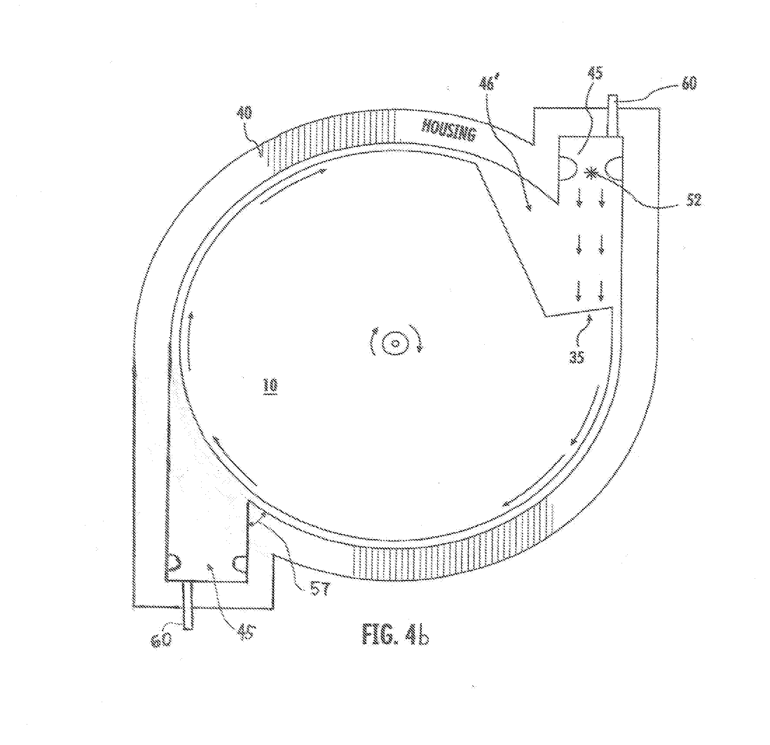

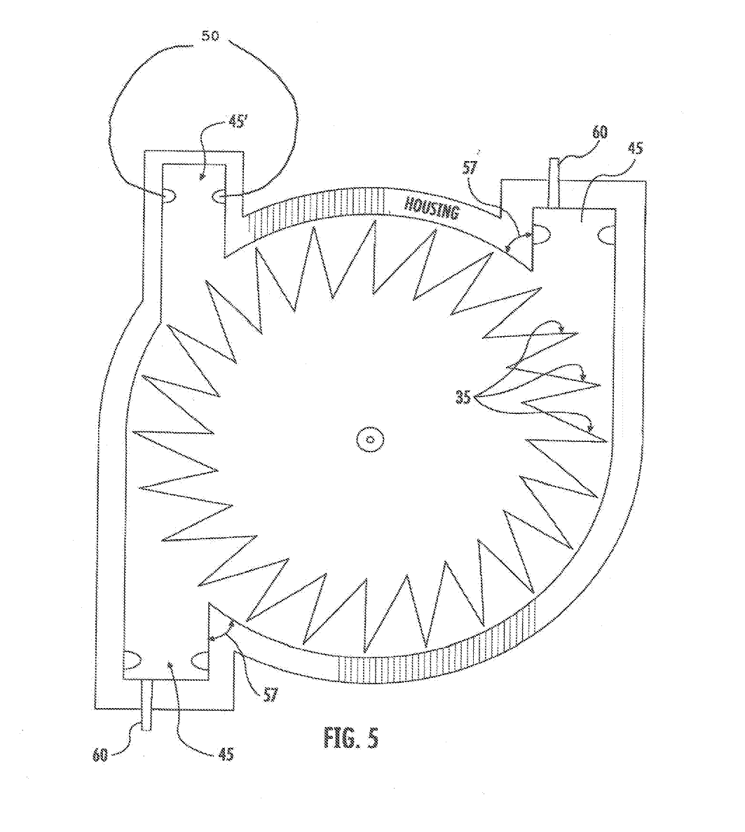

FIG. 4a illustrates the energy burst engine block 40 and rotor 10 with a single energy burst ignition chamber 45 and a single energy burst expansion chamber 46′. As shown here the energy burst ignition chamber 45 is in fluid communication with the energy burst expansion chamber 46′. In some embodiments the energy burst ignition chamber 45 is considered a part of the energy burst expansion chamber 46′ as shown. In some embodiments the energy burst ignition chamber 45 is partially separated with addition housing 40 from the energy burst expansion chamber 46′ while remaining in fluid communication. In other embodiments, the energy burst ignition chamber 45 is not in fluid communication with the energy burst expansion chamber 46′. In some embodiments there is an expandable material or device that extends across the opening 48 (see FIG. 2) that is stretched or expanded by the energy burst and strikes the leading edge 35. This could be done to help preserve some of the gas.

The nozzle 60 can be used to vacuum out the engine and/or fill it with the gas mixture. The electronics can be hooked up or connected in their appropriate locations. FIG. 4a illustrates the electronics simply as the knobs 50.

The energy burst 54 is illustrated in the energy burst ignition chamber 45 by the asterisk between the two knobs 50. In order to produce more work the ignition could be timed to when the energy burst expansion chamber 46 is oriented such that the position of the rotor presents a leading edge 35 that when struck by the expanding gases produced by the energy burst 52 results in an optimal rotation of the rotor 10 and thereby producing the most work. As the rotor 10 rotates around, additional energy burst 52 can be produced to continue the process. The shaft could be used to drive an alternator or generator to charge any type of electronic device as needed. The turning shaft could also perform other work as is known in the art.

FIG. 4b illustrates the energy burst engine block 40 and rotor 10 with two energy burst ignition chamber 45 and a single energy burst expansion chamber 46′. More energy burst ignition chambers 45 could be included in some uses. As shown here the energy burst ignition chambers 45 are in fluid communication with the energy burst expansion chamber 46′. In some embodiments the energy burst ignition chambers 45 are considered a part of the energy burst expansion chamber 46′ as shown. In some embodiments the energy burst ignition chambers 45 are partially separated with addition housing 40 from the energy burst expansion chamber 46′ while remaining in fluid communication. In other embodiments, the energy burst ignition chambers 45 are not in fluid communication with the energy burst expansion chamber 46′. In some embodiments there is an expandable material or device that extends across the opening 48 (see FIG. 2) that is stretched or expanded by the energy burst and strikes the leading edge 35. This could be done to help preserve some of the gas.

The nozzle 60 can be used to vacuum out the engine and/or fill it with the gas mixture. The electronics can be hooked up or connected in their appropriate locations. FIG. 4b illustrates the electronics simply as the knobs 50.

The energy burst 54 is illustrated in the energy burst ignition chamber 45 by the asterisk between the two knobs 50. In order to produce more work the ignition could be timed to when the energy burst expansion chamber 46 is oriented such that the position of the rotor presents a leading edge 35 that when struck by the expanding gases produced by the energy burst 52 results in an optimal rotation of the rotor 10 and thereby producing the most work. As the rotor 10 rotates around, additional energy burst 52 can be produced in one or both chambers 45 to continue the process. The shaft could be used to drive an alternator or generator to charge any type of electronic device as needed. The turning shaft could also perform other work as is known in the art.

As illustrated in FIG. 5 an energy burst engine 1 with multiple energy burst ignition chambers 45 and multiple energy burst expansion chambers 46 is embodied. In this figure, the energy bursts 52 can strike the rotor 10 at more locations as there are more leading edges 35 to strike. Position of the rotor 10 in this embodiment may not be as important for some applications as with rotors 10 having only a single leading edge 35 as in FIG. 4. A timing device may also not be as important in some applications as there is always a leading edge(s) that can be struck with any energy burst within the ignition chamber 45. In some embodiments, this figure can be described as circular, elliptical

Also as illustrated, the invention may also include multiple energy ignition chambers 45/45′. The opposing energy ignition chamber 45′ is constructed such that the energy burst 52 coming from that ignition chamber strikes the rotor 10 on what has been called the trailing edge. This can result in the rotor reversing, stopping, or just slowing. A different amplitude of energy burst can be present in each of the ignition chambers 45. Without the opposing ignition chamber 45′ the two energy burst expansion chambers 45 can be used to increase the power if desired. This design shows the flexibility of this engine in size, shape, thickness, number of ignition chambers and number of expansion chambers. Different angles 57 can also be used to minutely adjust the desired performances.

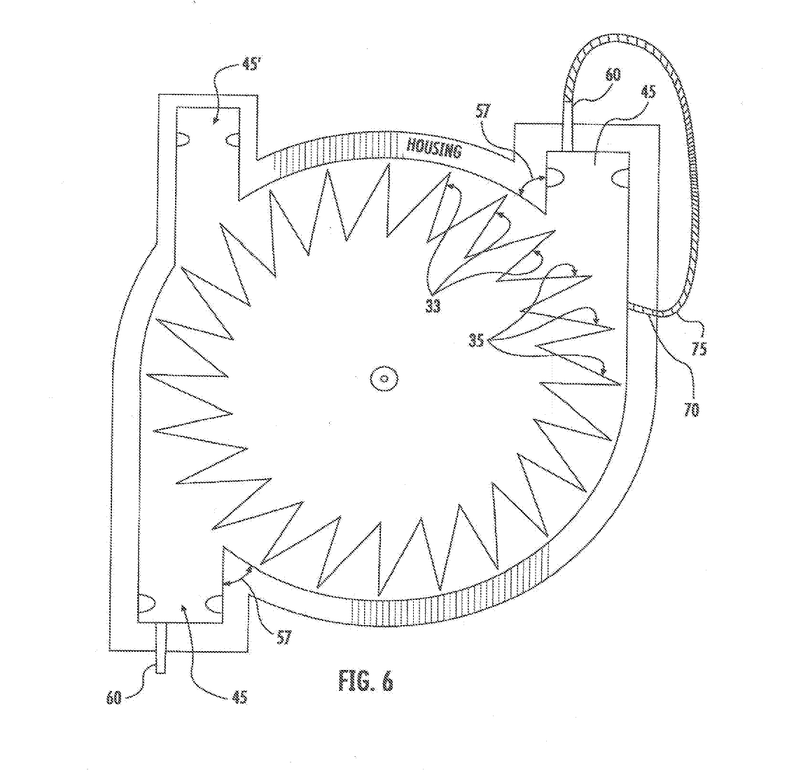

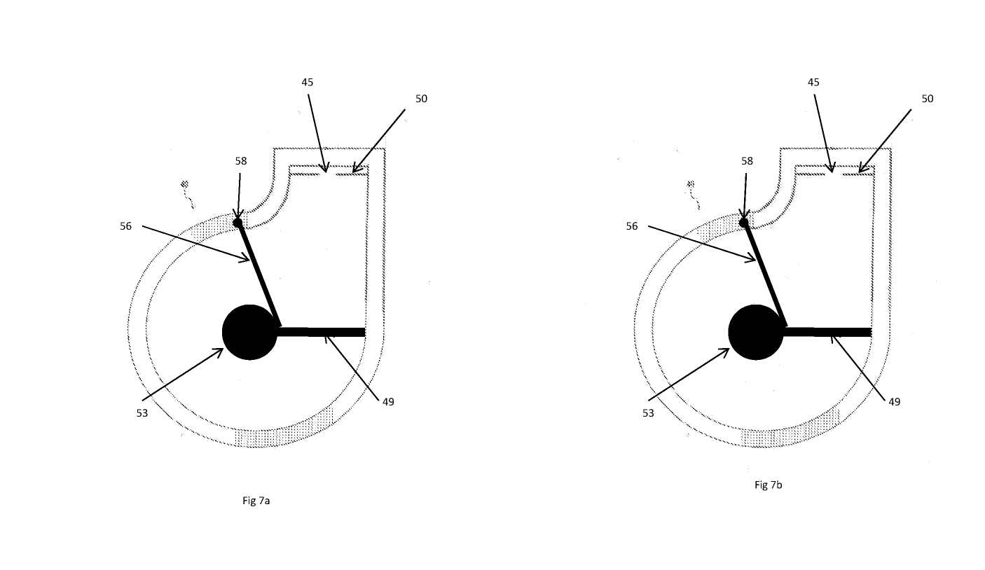

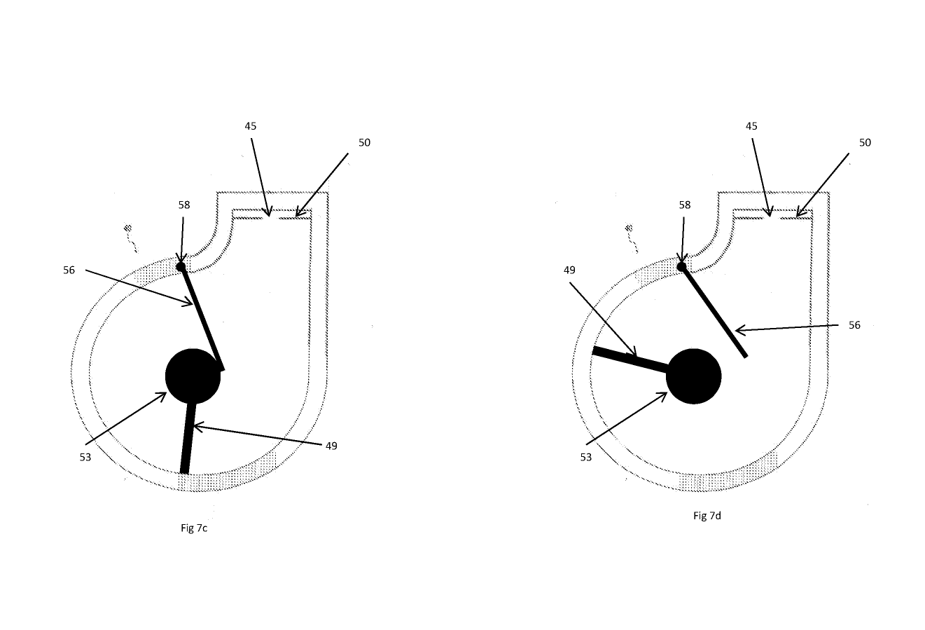

As illustrated in FIG. 6, a pressure valve 70 and line 75 in fluid communication with ignition chamber 45 and/or expansion chamber can be used to receive a portion of the expanding gas from the energy burst and send it back to the ignition chamber 45. Though shown on an engine having multiple ignition chambers 45, one or more pressure valves 70 (can also be pressure balancing valves) and lines 75 can be used in an engine having only one ignition chamber. Likewise, one or more valves and lines can also be used in an engine having multiple ignition chambers 45. In some embodiments, some ignition chambers 45 may have no pressure valves 70 or lines 75 while other ignition chambers 45 have 1 or more pressure valves 70 or lines 75 feeding back to it. All of this applies to opposing ignition chambers 45′ as well. The valves and lines may improve the loss of gas mixture within the engine and/or help in regulating the power delivered to the rotor. In some embodiments multiple sets of pressure valves 70 and lines 75 carry the gasses to a single chamber 45. In some embodiments one or more sets of pressure valves 70 and lines 75 carry gases to an outside chamber to then be distributed to multiple chambers 45 or to a single chamber 45.

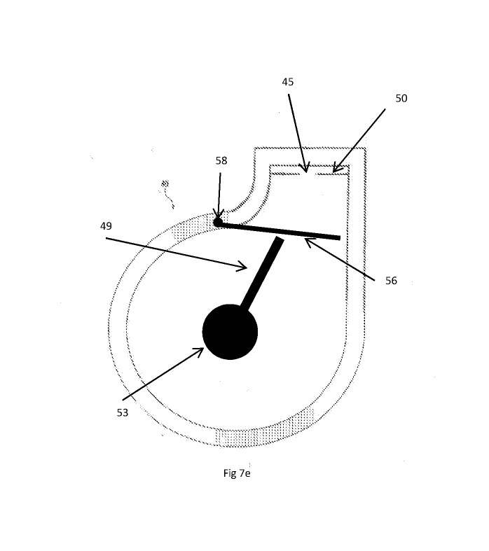

In FIGS. 7a-7e an engine 40 having a rotor 49 and a valve 56 is illustrated through the time of ignition to complete rotation of the rotor. The valve 56 is syncronized with the rotor 49 such that as ignition begins creating an energy burst in the ignition chamber 45 as shown in FIG. 7a the valve is in the open position in the proximity of the shaft portion 53 of the engine 40. This can allow the pressure to remain more localized and intense than if the gas mixture was free to expand throughout the entire interior of the engine 40. In FIG. 7b the rotor 49 and valve 56 remain unmoved as the pressure builds up. The valve 56 can rotate about rotation means 58 from the open and closed position (and vice versa). This is obviously a very fast step and is simply shown for illustration.

Once the rotor 49 moves as in FIG. 7c, the valve 56 is syncronized to begin its movement. This movement is illustrated in FIG. 7d. The rotor 49 continues to rotate and the valve 56 begins to move out of the open position and close toward the ignition chamber 45. In FIG. 7e the rotor 49 continues to rotate as the valve 56 moves to a closed position such that the rotor can rotate past the valve and return to the position of FIG. 7a with the valve 56 returned to the open position. The valve can close and open on each rotation. In some embodiments the valve is attached to the shaft itself and maintains a substantially fixed position in relation to the rotor during rotation caused by the gas expansion. The valve and rotor(s) can be synchronized with a single device or can be synchronized using independent devices.

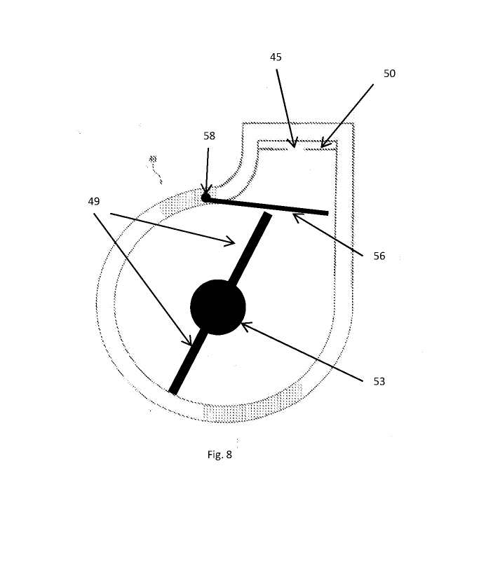

In FIG. 8 there are two rotors 49 on the shaft 53. As shown a valve 56 is also used. The valve and rotors act similarly to the motion illustrated in FIGS. 7a-7e. The valve 56 of FIG. 8 moves in such a way that it does not interfere with the rotation of either rotor 49. The valve 56 sometimes is initiated more quickly when there are two rotors. In fact the ignition chamber 45 can be timed to fire twice over one rotation in order for the pressure to act on each rotor 49. In some embodiments having multiple rotors a valve is not used.

In some embodiments, that apply to at least one and perhaps all of the embodied engine designs of this application, the pressure build-up in the ignition chamber involves plasma and/or nuclear change in and/or to the gas mixture used.

It should be noted that there are other ways than electrical means in which to activate the gas expansion within an energy burst ignition chamber 45. In some embodiments the activation device used for the gas expansion can be created using an activation device that utilizes an electric charge, an electric impulse, an electromagnetic frequency, heat, a spark, a flame, a magnetic impulse, high pressure, or any combination of initiators thereof.

It should be further noted that this invention provides for a lack of compression stroke in its operation. Also, it should be emphasized that this invention is not dependent upon air or oxygen to function. In fact, in many embodiments, Oxygen and/or air are not wanted. The system is also sealed and the gases are reused in many embodiments.

For the purposes of this disclosure, like reference numerals in the figures shall refer to like features unless otherwise indicated.

The above disclosure is intended to be illustrative and not exhaustive. This description can suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. An engine comprising a rotor disposed within a housing having a side wall, a top portion, and a bottom portion, the housing includes at least one energy burst ignition chamber and electrical device that introduces an electric charge into the at least one energy burst ignition chamber, the rotor is constructed and arranged to spin within the housing by action of a force, the at least one energy burst ignition chamber constructed and arranged to electrically react with the gas mixture disposed in the at least one chamber such that the gas mixture expands and drives the rotor, a control system for introducing electric charges into at least one energy burst ignition chamber at a controlled time interval, further the system is sealed and air-tight having an oxygen-free gas mixture therein.

2. The engine of claim 1 wherein the rotor is substantially elliptically shaped with a perimeter and having an axial thickness and a radial diameter, the rotor having at least one notched portion, the at least one notched portion including a vector face constructed and arranged to be axially aligned with a radial line extending radially from the center of the rotor.

3. The engine of claim 2 wherein the at least one energy burst ignition chamber is constructed and arranged to be substantially orthogonal to a radial line extending radially from the center of the rotor.

4. The engine of claim 2 having a greater number of energy burst ignition chambers than the number of at least one notches.

5. The engine of claim 1 wherein at least one of the energy burst ignition chambers is constructed and arranged to dampen the rotation of the rotor.

6. The engine of claim 1 wherein at least one of the energy burst ignition chambers is constructed and arranged to reverse the rotation of the rotor.

7. The engine of claim 1 wherein a gas mixture is included within the at least one ignition chamber, the gas mixture selected from the group consisting essentially of one or more noble gases, one or more homonuclear diatomic molecules, one or more halogens, and any combination thereof.

8. The engine of claim 7 wherein the gas is nitrogen.

9. The engine of claim 1 wherein the gas mixture is free of regular air.

10. The engine of claim 1 wherein the notches on the rotor can have any shapes as desired to catch the expansion.

11. The engine of claim 2 having multiple notches and multiple ignition chambers.

12. The engine of claim 1 wherein the housing includes at least one pressure relief tube that vents back around to the ignition chamber.

13. The engine of claim 1 wherein a valve within the housing and outside the ignition chamber is constructed and arranged to direct the flow of the expanding gas out of the ignition chamber.

14. The engine of claim 1 wherein the ignition chamber is constructed and arranged to direct the expansion.

15. An engine comprising a rotor disposed within an air-tight sealed housing having a side wall, a top portion, and a bottom portion, the housing includes at least one energy burst ignition chamber, at least one activation device, and a valve; the rotor is constructed and arranged to spin within the housing by action of a force, the at least one energy burst ignition chamber constructed and arranged such that the activation device activates a gas mixture disposed in the at least one chamber such that the gas mixture expands and drives the rotor; the valve being open when the gas mixture is ignited and when the pressure begins to drive the rotor, the valve being closed to provide for full rotation of the rotor.

16. The engine of claim 15 wherein a gas mixture is included within the at least one ignition chamber, the gas mixture selected from the group consisting essentially of one or more noble gases, one or more homonuclear diatomic molecules, one or more halogens, and any combination thereof.

17. An engine comprising a rotor disposed within a sealed airtight housing having a side wall, a top portion, and a bottom portion, the housing includes at least one oxygen free energy burst ignition chamber and at least one activation device, the rotor is constructed and arranged to spin within the housing by action of a force, the at least one energy burst ignition chamber constructed and arranged such that the activation device activates an oxygen free gas mixture disposed in the at least one chamber such that the gas mixture expands and drives the rotor.

18. The engine of claim 17 wherein the activation device introduces an initiator selected from the group comprising: an electric charge, an electric impulse, an electromagnetic frequency, heat, a spark, a flame, a magnetic impulse, high pressure, or any combination thereof.

19. The engine of claim 17 having a control system for controlling the activation device such that the initiator is introduced into at least one energy burst ignition chamber at a controlled time interval.

20. The engine of claim 17 wherein the housing includes at least one pressure tube that vents back to the ignition chamber.
